(19) United States
(12) Patent Application Publication
(10) Pub. No.: US 2008/0040377 A1
(43) Pub. Date: Feb. 14, 2008

(54) Apparatus and Method for Determining a User Preference

(75) Inventors: Myriam Ribiere, Nozay (FR); Makram Bouzid, Palaiseau (FR); Patricia M. Charlton, London (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/577,228

(22) PCT Filed: Oct. 17, 2005
(86) PCT No.: PCT/US05/37022

§ 371 Date: Apr. 13, 2007

(30) Foreign Application Priority Data
Oct. 20, 2004 (GB) 0423307.8

(51) Int. Cl. G06F 7/00

(52) U.S. Cl. 707/102; 707/E17.005

(57) ABSTRACT

A user device comprises an access interface (109) for accessing a web service by exchanging information with the web service over the Internet (105). An application processor (107) executes a user application accessing the web service through the access interface (109) and the Internet (105). The application processor (107) is connected to an ontology processor (111) which determines an ontology associated with at least some of the information exchanged with the web service. For example, the ontology may relate to a data structure of data objects communicated between the application processor (107) and the web service. The user device (101) further comprises a preference detector (113) which determines a user preference indication in response to the ontology and the exchanged information. The preference detector (113) is connected to a preference processor (115) which determines a user preference in response to the user preference indication.

### FIELD OF THE INVENTION

The invention relates to a method and apparatus for determining a user preference in response to an access of a web service.

### BACKGROUND OF THE INVENTION

In the last decade, the popularity of the Internet has increased explosively and an increasing number of services and applications exploiting the potential of the Internet have been developed.

In recent years, the concept of web services has been introduced. In contrast to traditional web browsing services wherein a web site interfaces directly with a user, a web service provides for a serving application to interface with a client application. The client application may provide a user interface for presenting information to a user and for receiving a user input. Hence, web services generally describe specific functionality by e.g. a company for providing another application the service through typically an Internet connection.

The opportunities offered by web services are very attractive for many service providers and a complete framework has been defined for some web services in order to allow a broad and standardised operation. In articular, a framework has been established for some web services in order to allow applications to interface with the web services without prior knowledge of exact characteristics and requirements of the service. The framework provides for exchange of information between the application and the web service in order to allow the application to be modified. For example, the framework provides for a service description to be provided to the application allowing the application to determine the input parameters required by the service and the output results that may be obtained. This service description is a key enabler for service discovery and invocation in many web service applications.

In particular the communication protocols UDDI (Universal Description, Discovery and Integration) and WSDL (Web Service Description Language) have been defined by W3C (World Wide Web Consortium) for setting up web services. The communication protocol UDDI is used for registering a web service on a centralised repository or service directory, which for example may be accessed as a web site. Hence UDDI is used by the web service when publicising and advertising the service. UDDI specifically allows exchange of information identifying the type of service and the entity providing the service.

WSDL is a communication protocol which is used for exchanging information directly between the web service and an application. WSDL provides for a description of inputs, outputs, operations and messages which are generated or required by the service. Thus, WSDL provides for an interface description for the web service that allows an application to adapt to the current web service. During operation, the user application and the web service exchange information. In particular, the information may be exchanged using the SOAP protocol which has been defined by W3C. Specifically, the application and web service may exchange SOAP messages containing instances of inputs and outputs over typically the Internet.

The WSDL description of inputs and outputs identifies resources needed to run the service correctly. Those resources can be defined into a language known as XML Schema. The purpose of an XML Schema is to define the legal building blocks of an XML document, just like a DTD (Document Type Definition). However, in semantic web services the resources may be represented by elements of an ontological vocabulary, represented into an XML-based ontological representation language such as RDFS(Resource Description Framework Schema).

An ontology is a shared understanding of some domain of interest. In particular, an ontology provides a reference frame and definition for various concepts used in a particular domain. A concept can be a physical (concrete) object of the domain (a book in the domain of book sellers) or an abstract object (the selling book process in the domain of book sellers). A number of different properties (parameters and characteristics) of a given concept may be represented in an ontology. Thus, for a defined ontology which is shared between applications and web services, the different applications and web services may exchange information relating to characteristics of objects (concrete or abstract) by using the defined ontology. This allows web services and applications to accurately and effectively exchange information without requiring the objects to be predefined at the time of the design of the web services and applications. Thus ontologies are used for sharing a consistent understanding of what information means and also allows knowledge re-use as a common reference for different web services and applications.

In order to enhance the user experience, there is a desire to personalize web services for the individual user. However, the personalization of services or applications is problematic and is typically addressed from the service or application perspective. Hence, web services are known which develop and store internal user profiles allowing them to customize the service based on user preferences. However, this knowledge about the user is local to the particular service and therefore cannot be reused by the user for another service even if this service is of the same type.

An approach that has been adopted to address this problem is to define a user model for applications. However, the definition of such user models has mainly been addressed for standalone applications. In such context, the user model contains type of preferences that are defined at the time of the design of the application (e.g. editing preferences, display preferences etc.). However, this results in an inflexible and static personalization of web services from the user perspective, because the set of predefined type of preferences can not be extended or change at run time. For example, a user may change preferences or develop new preferences during use, and it is therefore not possible to generate an accurate user profiled during the design phase. From the user perspective it is difficult to define at design time, which type of preferences the system will use to access any kind of services or applications.

Although some approaches have been proposed for modifying or updating such user profiles, these approaches tend to be very complex, require large storage and to be dependent on specific characteristics of the individual service.

Hence, an improved system for determining a user preference would be advantageous and in particular a system allowing increased flexibility, reduced complexity, reduced storage requirements, improved portability, improved compatibility with different services, improved accuracy, applicability to different web services and/or improved personalisation of web services would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention, there is provided an apparatus for determining a user preference comprising: means for accessing a web service by exchanging information with the web service; means for determining an ontology associated with at least some information exchanged with the web service; means for determining a user preference indication in response to the ontology and the at least some information; and means for determining the user preference in response to the user preference indication.

The invention may allow in improved user preference to be determined. The invention may in particular enable or facilitate user preference (e.g. preference type and/or preference value) determination based on actual web service access characteristics. A user preference may be determined at run time for an application rather than requiring a user preference to be determined when designing the application. The invention may facilitate determining a user preference which is not limited to the specific web service and/or does not require all characteristics of the web service to be known in advance. A highly flexible system for determining a user preference may be provided. The system may be compatible with a large range of web services and in particular an ontology based approach may allow user preference indications to be determined based on information from interactions with the web service without the application having predetermined (design time) information of characteristics of this information.

Hence, by representing information exchanged with the web service by an ontology representation language, web service interoperability and application run-time configurability may be facilitated and/or improved. For example, by including ontological elements in web service descriptions, the web service provider may ensure that a common understanding of the inputs and outputs of the web service is achieved thereby facilitating user preference determination based on this input and/or output.

The invention may enable or facilitate a dynamic creation or modification of a user preference based on interactions between the application and web services.

The invention may allow a more dynamic and/or variable user preference to be developed. For example, the invention may facilitate detection of new preferences as these may readily be detected based on the ontology information.

The exchanged information may be sent to the web service and/or received from the web service. In some embodiments, the user preference indication may in itself be a user preference and in particular the determined user preference and the user preference indication may be identical.

According to an optional feature, the at least some information comprises data objects comprising a data structure compliant with the ontology. This may facilitate and/or improve the determination of the user preference. The data objects may for example relate to items, such as a book, to be purchased or information elements being exchanged, such as tourist information.

According to an optional feature, the at least some information comprise SOAP messages. This may provide an efficient implementation and may in particular provide compatibility with web service frameworks specified by W3C.

According to an optional feature, the means for determining the ontology is operable to determine the ontology in response to received information associated with the web service. This may facilitate the determination of the ontology and/or may provide a flexible and/or low complexity means of dynamically adapting the operation to the current characteristics. The received information may for example comprise a specific data object description received from the web service during access initiation. The specific data object description may comprise an identification of data objects to be exchanged and may provide an ontology indication for one or more of these data objects.

According to an optional feature, the received information comprises WSDL information. This may provide an efficient implementation and may in particular provide compatibility with web service frameworks specified by W3C.

According to an optional feature, the means for determining the user preference indication is operable to determine the user preference in response to a service type of the web service. This may provide for a low complexity implementation and/or provide an improved quality user preference. In particular it may in many embodiments provide for a simple yet accurate determination of the user preference.

According to an optional feature, the means for determining the user preference indication is operable to determine the user preference in response to a service description of the web service. This may provide for a low complexity implementation and/or provide an improved quality user preference. In particular it may in many embodiments provide for a simple yet accurate determination of the user preference.

According to an optional feature, the means for determining the user preference indication is operable to determine the user preference in response to a service instance message associated with the web service. This may provide for a low complexity implementation and/or provide an improved quality user preference. In particular it may in many embodiments provide for a simple yet accurate determination of the user preference.

According to an optional feature, the service instance message is an output service instance message from the web service. This may provide for a low complexity implementation and/or provide an improved quality user preference. In particular, it may in many embodiments provide for a simple yet accurate determination of the user preference. In many embodiments, the output service instances may provide additional information which cannot be determined from the input service instance messages. For example, for a purchasing web service, an input service instance may require selection of a product, such as a book, by specific parameters, such as a title. However, the output instance message comprising data of the selected product, such as the selected book, may provide much more information, such as a physical size, number of pages etc. Hence, the output instance message may provide information which cannot be derived from the input instance messages thereby allowing for additional user preference determination.

According to an optional feature, the apparatus further comprises means for creating a user preference in response to a detection of a service type of the web service meeting a criterion. This may provide for a low complexity implementation and/or provide an improved quality user preference. In particular, it may in many embodiments provide for a simple yet accurate determination of the user preference. The criterion may be used to bias the user preference determination towards a desired characteristic or behaviour. For example, the criterion may be that the service type is a new or rarely accessed service type thereby biasing the user preference determination towards detecting new preferences.

According to an optional feature, the apparatus further comprises means for creating a user preference in response to a detection of a service description characteristic of the web service meeting a criterion. This may provide for a low complexity implementation and/or provide an improved quality user preference. In particular, it may in many embodiments provide for a simple yet accurate determination of the user preference. The criterion may be used to bias the user preference determination towards a desired characteristic or behaviour. For example, the criterion may be that the service description characteristic is indicative of a new or rare service characteristic thereby biasing the user preference determination towards detecting new preferences.

According to an optional feature, the apparatus further comprises means for presenting the user preference indication to a user; and the means for determining the user preference is further operable to determine the user preference in response to a user input. This may allow for the user preference to be controlled and/or influenced by the user. This may in particular allow a more accurate user preference to be determined. For example, a new user preference may be determined and presented to the user. If the user agrees with the determination, the user preference may be maintained and otherwise it may be ignored.

According to an optional feature, the apparatus further comprises means for determining a user profile in response to the user preference. This may provide for an improved personalisation of the apparatus and may for example provide an improved personalisation of future web services.

According to an optional feature, the apparatus further comprises means for storing the user profile using an ontology representation. This may facilitate interoperability. In particular it may facilitate interoperability between different services and may for example allow a user preference to be determined in response to accesses of a plurality of different services and to be used for a plurality of different services.

According to an optional feature, the apparatus further comprises means for accessing a different web service using the user preference. The invention may allow a user preference to be determined in response to accessing a first web service which may be used for personalising a second web service. In particular, by basing the user preference determination on an ontology approach an improved interoperability and compatibility between web services may be achieved.

According to an optional feature, the apparatus further comprises: means for accessing a different web service by exchanging information with the different web service; means for determining a second ontology associated with at least some information exchanged with the different web service; means for determining a second user preference indication in response to the second ontology and the at least some information exchanged with the different web service; and means for updating the user preference in response to the second user preference indication.

The invention may allow a user preference to be determined in response to a plurality of web services. This may allow a more accurate user preference to be determined. By basing the user preference determination on an ontology approach, an improved interoperability and compatibility between web services may be achieved. The second ontology may be the same as the first ontology.

According to an optional feature, the apparatus further comprises means for generating a user recommendation in response to the user preference. The invention may allow for accurate user recommendations to be determined in response to web service accesses

According to an optional feature, the means for determining the ontology is furthermore operable to determine the ontology in response to a service type of the web service. This may provide a low complexity and practical determination of the ontology.

According to an optional feature, the apparatus further comprises means for estimating a consistency between the user preference indication and an existing user preference; and the means for determining the user preference is operable to determine the user preference in response to the consistency. This may facilitate determination of the user preference and/or may increase the reliability of the determined user preference.

According to an optional feature, a representation of the user preference is in accordance with the ontology. This may facilitate interoperability. In particular it may facilitate interoperability between different services and may for example allow a user preference to be determined in response to accesses of a plurality of different services and to be used for a plurality of different services.

Optionally, the web service is a web service of a semantic web.

According to a second aspect of the invention, there is provided a method for determining a user preference comprising: accessing a web service by exchanging information with the web service; determining an ontology associated with at least some information exchanged with the web service; determining a user preference indication in response to the ontology and the at least some information; and determining the user preference in response to the user preference indication.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of a communication system comprising embodiments of the invention;

FIG. 2 illustrates an example of an upper level ontology in accordance with embodiments of the invention; and

FIG. 3 illustrates an example of a construction of a topology representation of a user preference in accordance with embodiments of the invention.

### DETAILED DESCRIPTION OF EMBODIMENTS OF THE INVENTION

The following description focuses on embodiments of the invention applicable to a web service provided over the Internet. However, it will be appreciated that the invention is not limited to this application but may be applied to many other networks and communication systems.

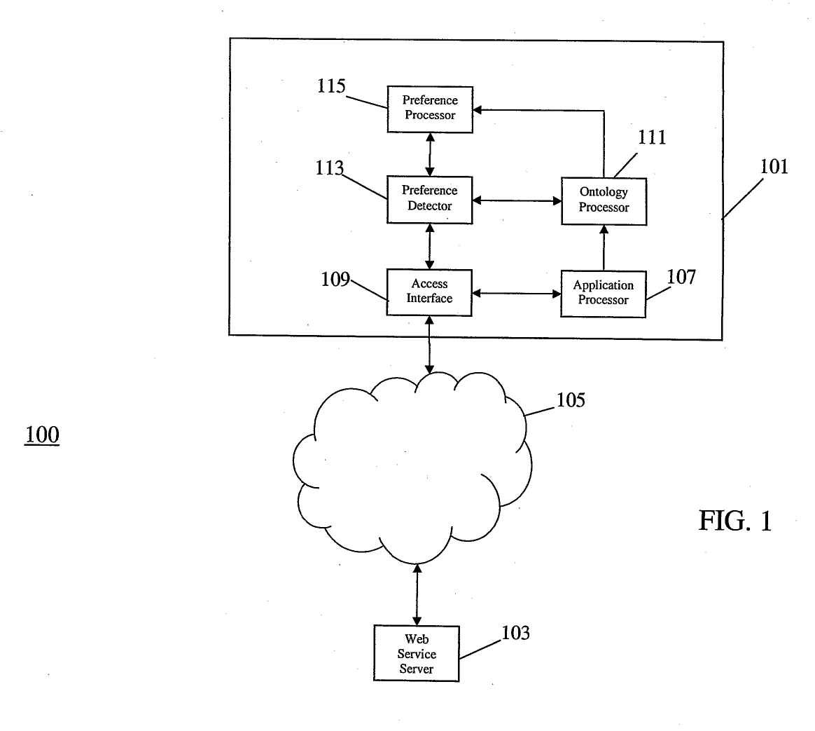

FIG. 1 is an illustration of an example of a communication system comprising embodiments of the invention.

The communication system comprises a user device 101 which is in communication with a web service server 103 through the Internet 105. The web service server 103 provides a web service which is accessed by the user device 101. The user device 101 comprises an application processor 107 which executes a user application that interoperates with the web service executed by the web service server 103.

The web service may for example be an online shopping web service allowing a number of products, such as e.g. books, to be purchased. The user application may thus interface with a user of the user device 101 and the web service in order to allow online product browsing, product selection, payment etc.

The application processor 107 is coupled to an access interface 109 which provides an interface to the Internet 105. The access interface 109 receives and transmits information from and to the Internet and specifically exchanges information with the web service. The access interface 109 may comprise a broadband or dial up modem as well as firmware for interfacing to other elements of the user device.

The user device additionally comprises an ontology processor 111 which determines an ontology for at least some of the information being exchanged with the web service. Specifically, the ontology may define a data structure of some or all of the data objects or resources which are exchanged with the web service. For example, for an online shopping web service, the ontology may for example define a data structure for the representation and information exchange of data objects defining the products. As another example, for an application providing tourist information, the ontology may define a data structure for information objects such as tourist sights, hotels or restaurants.

In some embodiments, the ontology processor 111 may for example determine the ontology in response to information received from the web service and/or in response to a service type of the web service. For example, the web service may directly or indirectly communicate an indication of which data objects will be used and which ontology is used for these data objects. Additionally or alternatively the ontology processor 111 may simply select one or more ontologies suitable for the current type of web service, e.g. if the current web service is a an online book selling web service, the ontology stored for book data objects may be selected.

In the embodiment of FIG. 1, the ontology processor 111 is coupled to the application processor 107. The application processor 107 may in the example provide information to the ontology processor 111 which allows the appropriate ontology (or ontologies) to be determined. For example, the application processor 107 may provide information to the ontology processor 111 indicating a service type and the ontology processor 111 may select an ontology from a number of stored ontologies. For example, the application processor 107 may indicate that the user application relates to online purchasing of books and in response the ontology processor 111 may select a stored ontology defining a data structure for data objects identifying books.

The information from the application processor 107 may be independent of which specific web service is being accessed. Hence, regardless of which online vendor of books is providing the current web service, the same ontology may be used.

The user device 101 further comprises a preference detector 113 which may determine a user preference indication. The preference detector 113 is coupled to the ontology processor 111 and to the access interface 109.

In use, the preference detector 113 may determine a user preference indication in response to the ontology and the information exchanged with the web service. For example, the preference detector 113 may monitor the communication between the user application and the web service and may interpret the communicated data using the ontology determined by the ontology processor 111. E.g. the preference detector 113 may detect all book selections made by the user application and may interpret the data objects using the selected ontology. For example, if a user purchases a specific book, the preference detector 113 may determine the user preference indication as the ontological representation of the book. In many embodiments, the generated user preference indication is represented in accordance with the ontology determined by the ontology processor 111.

The preference detector 113 is coupled to a preference processor 115 which is operable to receive the user preference indication and to determine a user preference depending on the user preference indication. In particular, a user preference indication may be determined for each object selected by the user application and the preference processor 115 may determine a user preference by identifying frequently selected characteristics. Thus, if, for example, a large number of books are purchased by a user, a user preference indication may be generated for each purchase and a user preference for e.g. a specific author may be generated if a the proportion of purchased books with this author exceeds a given level. In many embodiments, the generated user preference is represented in accordance with the ontology determined by the ontology processor 111.

The ontology based approach allows for an improved interoperability between different web services. For example, each online book store may use the same ontology for a book data object. Accordingly, the user preference indication may be determined for all the web services accessed for purchasing books. Thus, the user preference may in particular be determined in response to accesses of different web services. Accordingly, the generated user preference may be used for different web services and is not locally determined or specific to the web service.

In some embodiments, the user device 101 is thus operable to access different web services using the determined user preference. For example, in some embodiments a user preference may be determined in response to accessing a first web service. When a second and similar type of web service is subsequently accessed, the user device may communicate the user preference (or parts thereof) to the second web service thereby allowing this to be personalised based on the information extracted when accessing the first web service.

FIG. 1 illustrates functional blocks of the user device of some embodiments of the invention. The individual functional blocks may for example be implemented in a suitable processor such as a microprocessor, a microcontroller or a digital signal processor. The functions of the illustrated blocks may for example be implemented as firmware or software routines running on suitable processors or processing platforms. However, one, more or all of the functional blocks may be implemented fully or partially in hardware. For example, the functional blocks may be fully or partially implemented as analogue or digital logic or circuitry.

The functional blocks may furthermore be implemented separately or may be combined in any suitable way. For example, the same processor or processing platform may perform the functionality of more than one of the functional blocks. In particular, a firmware or software program of one processor may implement the functionality of two or more of the illustrated functional blocks. For example, the application processor 107, the ontology processor 111, the preference detector 113 and the preference processor 115 as well as elements of the access interface 109 may be implemented as different firmware routines running in a single processor. The functionality of different functional modules may for example be implemented as different sections of a single firmware or software program, as different routines (e.g. subroutines) of a firmware or software program or as different firmware or software programs.

The functionality of the different functional modules may be performed sequentially or may be performed fully or partially in parallel. Parallel operation may include a partial or full time overlap between the performed functions.

The functional elements may be implemented in the same physical or logical element or may,be distributed across a plurality of physical or logical elements.

The web service provided by the web service server 103 may in some embodiments be a web service of a semantic web and may in particular in some embodiments operate in accordance with the web service framework developed by W3C. However, it will be appreciated that this is merely an example and that for example any suitable service description language and any suitable information exchange protocol may be used.

In the example embodiments, the web service may use a UDDI protocol for registering at a suitable web server, WSDL for exchanging service description information and SOAP messages for the ongoing interaction between the user application and the web service.

In some of the exemplary embodiments, the available web services may be partitioned into clusters based on their type (as identified in the UDDI description or in e.g. a OWL-S (Ontology Web Language-Service Description Ontology) description of the service). The web services communicate with the user application by exchanging resources through SOAP request/response. Those resources are collected and analysed by the user device 101.

In a semantic web, the resources exchanged on the Internet may be represented in accordance with ontologies which specifically may be described in the RDFS (Resource Description Framework Schema) or OWL (Ontology Web Language) protocols. These ontologies may thus be used to extract the user preference indication and may be used to define user preferences and to e.g. indicate preferred values of resource properties. Thus, the use of ontologies may provide an open and dynamic representation of user preferences.

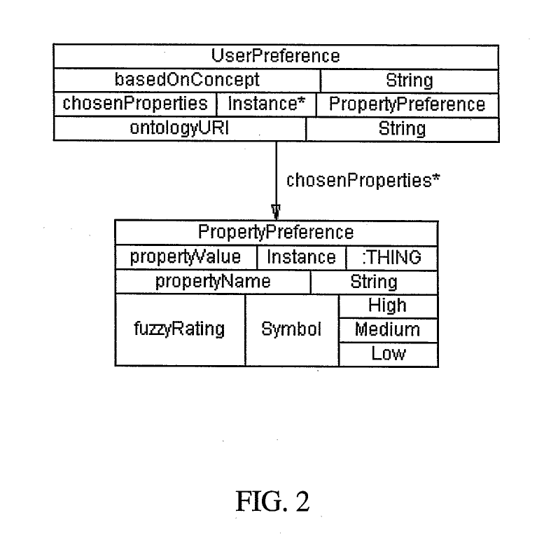

FIG. 2 illustrates an example of an upper level ontology which may be used. FIG. 2 in particular illustrates an example of an ontology framework which may be used to define any kind of preference. In the specific example, a user preference is defined by three main elements: the type of resource that interest the user, the ontology where this resource is described and a list of preferred properties. Each preferred property is described by its name, the chosen property value and the rating of this value.

In some embodiments, the preference detector 113 may determine the user preference indication in response to a service type of the web service and/or a service description of the web service. For example, the preference detector 113 may monitor the service descriptions for a new web service and may determine a user preference indication indicating that a specific type web service has been accessed. The user preference indication may thus indicate that the user has a preference for e.g. the information or products associated with this web service. In particular, the preference detector 113 may generate a user preference indication whenever it detects that a new type of service is being accessed. Hence, if the user accesses an online book seller for the first time, the preference detector 113 may generate a user preference indication indicating that a user has an interest in online purchasing of books.

Alternatively or additionally, the preference detector 113 may determine the user preference in response to a service instance message associated with the web service. The service instance message may be an input or output message for the web service and may in particular be a request or response SOAP message.

The preference processor 115 determines a user preference in response to the user preference indication. The user preference may be a new user preference indicating a newly detected preference or may be an existing user preference which is updated in response to the user preference indication. Thus, in combination, the user preference indication and preference processor 115 may provide a learning function which may create and update an ontology based user preference in response to the accessing of web services.

Thus, in some embodiments the user device 101 may analyse the type of interest of the user based on the type of service identified by the UDDI and the WSDL description of the web service. The user device may thus monitor the type of service that the user application is interacting with. A suitable learning strategy may be based on the observation that web service descriptions mainly provide a profile of the web service where inputs, outputs and functionalities of the service are described. Inputs are input elements required to run the web service and outputs are output elements which provide the results of the web service to the user application. Some web services are known to generate local preferences in response to analysing the user inputs received from the user application. However, the Inventors have realised that for many web services the output may be even more interesting for determining user preferences.

For example, input elements do not always comprise all characteristics or parameters which may be used for developing a user preference and therefore additional information may be derived from the output. For example, an online book selling web service may require the name of an author or the title of a book in order to find a specific book. However, often people may choose a book according to other parameters such as the format or length of the book. E.g. people predominantly reading books in public transport may prefer a pocket format of any purchased book. This preference may be detected by analysing similarities of outputs from the web service identifying characteristics of the purchased books.

In some embodiments, the user device may comprise functionality for presenting the user preference indication and/or the user preference to a user and for receiving a user input. The user preference may then be determined in response to the user input. For example, the user preference may only be created if the user accepts the presented information.

In some embodiments, a new user preference may be created in response to a detection of a service type or a service description characteristic of the web service meeting a criterion. In particular, a new user preference may be created when the preference detector 113 detects a new web service type being accessed.

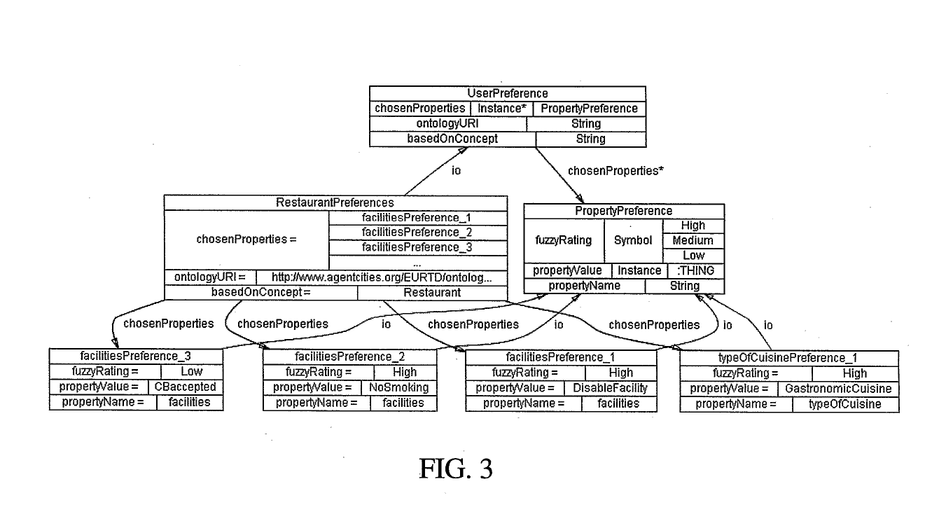

The preference processor 115 may for example dynamically create a new user preference using the ontology representation of FIG. 2 by instantiating the concept of UserPreference. FIG. 3 illustrates an example of a construction of a topology representation of a user preference. In the specific example, an ontology representation for a user preference for a Restaurant is illustrated. An instance of Restaurant can according to this exemplary ontology be described with the full set of properties defined in the ontology. In the example, the properties typeofCuisine and facilities are considered relevant for the current user preference. In the example, in order to create a new user preference, an instance of UserPreference and several instances of PropertyPreference are simply created using the upper ontology representation of FIG. 2.

The representation is applicable to any type of preference and dynamic environment since any new preference can be defined on any new resource. The representation language may for example be a RDF(S) or OWL (Ontology Web Language ontology representation language.

In some embodiments, the preference processor 115 may further determine a user a user profile in response to the user preference. The user profile may comprise a number of user preferences for a large variety of web services and/or data objects etc. The representation used for the user profile may in particular be an ontology representation and the user device 101 may comprise functionality for storing the user profile using the ontology representation.

The preference processor 115 may maintain a current user profile by extracting existing preferences from the current user profile and updating them according to user preferences and user preference indications determined in response to accesses of web services. For example, using the ontology representation of FIGS. 2 and 3, the preference processor 115 may in response to a user preference indication:
Change the rating of an existing PropertyPreference in an existing UserPreference,
Change the value and rating of an existing PropertyPreference,
Add a new PropertyPreference to an existing UserPreference, or
Add a new UserPreference with a set of PropertyPreference to the user profile.

In some embodiments, the user device 101 may comprise functionality for generating a user recommendation in response to a user preference. The user device may for example receive information related to a different type of web services or different types of information from a web site. These may be compared to the current user profile and if a match is found in accordance with any suitable match criterion, the web service or the information is presented to the user.

In some embodiments, the user device comprises functionality for estimating a consistency between the user preference indication and an existing user preference. Hence, a verification check may be determined when a new user preference indication is detected. If the user preference indication is considered to be consistent with the current user profile or user preference, the user preference may be updated whereas it may be ignored otherwise.

Specifically, in order to support such functionality for resolving conflicts or inconsistencies various CSP (Constraint Satisfaction Problem) may be used based on for example simple rule management or more complex control theory from planning and scheduling systems, monotonic reasoning, or possible world theorems (The person skilled in the art will appreciate that numerous suitable CSP algorithms are available). Thus in the example of the ontology representation of FIG. 2 and FIG. 3, the user device may determine that the user preference indication is ignored if the user preference indication is in conflict with the existing user profile or e.g. a PropertyPreference of a particular user preference.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented, at least partly, as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for determining a user preference comprising:
means for accessing a web service by exchanging information with the web service;
means for determining an ontology associated with at least some information exchanged with the web service;
means for determining a user preference indication in response to the ontology and the at least some information; and
means for determining the user preference in response to the user preference indication.

2. The apparatus claimed in claim 1 wherein the at least some information comprises data objects comprising a data structure compliant with the ontology.

3. The apparatus claimed in claim 1 wherein the at least some information comprise SOAP (Simple Object Access Protocol) messages.

4. The apparatus claimed in claim 1 wherein the means for determining the ontology is operable to determine the ontology in response to received information associated with the web service.

5. The apparatus claimed in claim 4 wherein the received information comprises WSDL (Web Service Description Language) information.

6. The apparatus claimed in any previous claim wherein the means for determining the user preference indication is operable to determine the user preference in response to a service type of the web service.

7. The apparatus claimed in claim 1 wherein the means for determining the user preference indication is operable to determine the user preference in response to a service description of the web service.

8. The apparatus claimed in claim 1 wherein the means for determining the user preference indication is operable to determine the user preference in response to a service instance message associated with the web service.

9. The apparatus claimed in claim 8 wherein the service instance message is an output service instance message from the web service.

10. The apparatus claimed in claim 1 further comprising means for creating a user preference in response to a detection of a service type of the web service meeting a criterion.

11. The apparatus claimed in claim 1 further comprising means for creating a user preference in response to a detection of a service description characteristic of the web service meeting a criterion.

12. The apparatus claimed in claim 1 further comprising means for presenting the user preference indication to a user; and wherein the means for determining the user preference is further operable to determine the user preference in response to a user input.

13. The apparatus claimed in claim 1 further comprising means for determining a user profile in response to the user preference.

14. The apparatus claimed in claim 13 further comprising means for storing the user profile using an ontology representation.

15. The apparatus claimed in claim 1 further comprising means for accessing a different web service using the user preference.

16. The apparatus claimed in claim 1 further comprising:
means for accessing a different web service by exchanging information with the different web service;
means for determining a second ontology associated with at least some information exchanged with the different web service;
means for determining a second user preference indication in response to the second ontology and the at least some information exchanged with the different web service; and
means for updating the user preference in response to the second user preference indication.

17. The apparatus claimed in claim 1 further comprising means for generating a user recommendation in response to the user preference.

18. The apparatus claimed in claim 1 wherein the means for determining the ontology is furthermore operable to determine the ontology in response to a service type of the web service.

19. The apparatus claimed in claim 1 further comprising means for estimating a consistency between the user preference indication and an existing user preference; and the means for determining the user preference is operable to determine the user preference in response to the consistency.

20. (canceled)

21. (canceled)

22. A method of determining a user preference comprising:
accessing a web service by exchanging information with the web service;
determining an ontology associated with at least some information exchanged with the web service;
determining a user preference indication in response to the ontology and the at least some information; and
determining the user preference in response to the user preference indication.

23. (canceled)

24. (canceled)
